(19) United States
(12) Patent Application Publication
(10) Pub. No.: US 2015/0273768 A1
(43) Pub. Date: Oct. 1, 2015

(54) CYLINDRICAL COORDINATE METHOD OF CALIBRATION FOR CNC APPLICATIONS

(71) Applicant: Alchemy 3D Labs LLC, San Diego, CA (US)

(72) Inventors: Travis I. Wyatt, San Diego, CA (US); Alexander W. Weiss, San Diego, CA (US)

(21) Appl. No.: 14/671,709

(22) Filed: Mar. 27, 2015

Related U.S. Application Data
(60) Provisional application No. 61/971,624, filed on Mar. 28, 2014.

(51) Int. Cl. B29C 67/00; G05B 19/414

(52) U.S. Cl. CPC B29C 67/0088; G05B 19/4145; B33Y 50/02

(57) ABSTRACT

This disclosure relates to systems, apparatus, and methods for producing three-dimensional (3D) objects in a manner more rapidly and cost efficiently than heretofore achievable. A cylindrical coordinate CNC system (CCCNC system) according to embodiments of this disclosure works by using a rotation and a translation or multiple rotations. In one aspect, a CCCNC system includes a bed that rotates on a platen. The platen translates from side to side (e.g., theta and r-axis, respectively). The rotating bed and the platen define the workspace for producing the 3D objects. In another aspect, the CCCNC system includes a head that moves up and down (z-axis) while remaining static in all other axes of motion. In various embodiments, the CCCNC system uses the r, theta, and z-coordinate system to execute any job or command of which a traditional Cartesian CNC system is capable.

### CROSS-REFERENCE TO RELATED APPLICATION

This application claims the benefit of and priority to U.S. Provisional Patent Application No. 61/971,624, filed Mar. 28, 2014, and entitled “Cylindrical Coordinate Method of Calibration for CNC Applications,” the entire disclosure of which is hereby incorporated by reference.

### BACKGROUND OF THE INVENTION

This disclosure generally relates to devices for building solid objects by layer-wise deposition of a material, otherwise known as additive manufacturing or three-dimensional (3D) printing. 3D printing is considered distinct from traditional machining techniques, which mostly rely on the removal of material by methods such as cutting or drilling (subtractive processes). A 3D object can be built up by a 3D printer by depositing one or more of a variety of materials over a fabrication platform, typically one layer at a time. After each layer is deposited and potentially allowed to cure, another layer may be deposited over all or part of the previous layer. This process allows 3D objects to be fabricated by repeating this process over several layers. These techniques allow for both rapid prototyping and distributed manufacturing with applications in architecture, construction, industrial design, automotive, aerospace, military, engineering, civil engineering, dental and medical industries, biotech (human tissue replacement), fashion, footwear, jewelry, eyewear, education, geographic information systems, food, and many other fields.

To perform a print, a 3D printer generally reads a design from a file and lays down successive layers of material to build a model represented in the design from a series of cross sections. These layers, which correspond to virtual cross sections derived from the design, are joined or automatically fused to create the final shape. The primary advantage of this technique is its ability to create almost any shape or geometric feature. As with traditional printers, 3D printers are also defined by printer resolution that describes layer thickness and an X-Y resolution representing the size of printed particles (3D dots), typically in dpi (dots per inch) or micrometers.

Cartesian coordinate CNC machines, such as 3D printers, laser cutters, etc., all require calibration before beginning the printing or machining process in order to define and constrain the “virtual workspace” (a means by which the Central Processing Unit (CPU) can relate the “virtual workspace” to the physical workspace). Without doing this, the printing or cutting may occur outside the physical confines of the physical workspace.

Typically, calibration is performed using one or more verification means, such as “endstops.” Endstops can be limit switches, photo-interrupters, or any sensor that can detect displacement or position that send a digital or analog signal to the CPU when the switch is pressed. When the calibration process is initiated, the head (object where printing or cutting is initiated) and/or the workspace (object on which the job is executed) moves to its maximum/minimum distance until it touches an endstop. When this occurs, the CPU then defines that as a known point in space, whether it be the origin or another arbitrary point.

However, the accuracy of the calibration for Cartesian coordinate systems does not need to be perfect. For example, if during the calibration process an endstop sends a signal too early to the CPU that the origin or arbitrary point has been reached, the CPU will think the head/bed is there physically, even though it could still be an inch away. In this situation, the part itself may remain unaffected during the printing/cutting process. The effect is only on the position of the part relative to the intended location of the job. If the user had intended the part to be printed/cut at the center, the part would be translated away from the center by the distance that the calibration was off. Essentially, the fidelity and accuracy of the part itself is unaffected.

Accordingly, what is desired is to solve problems relating to calibrating CNC systems that implement Cylindrical coordinate systems, some of which may be discussed herein. Additionally, what is desired is to reduce drawbacks relating to calibrating CNC systems that implement Cylindrical coordinate systems, some of which may be discussed herein.

### BRIEF SUMMARY OF THE INVENTION

The following portion of this disclosure presents a simplified summary of one or more innovations, embodiments, and/or examples found within this disclosure for at least the purpose of providing a basic understanding of the subject matter. This summary does not attempt to provide an extensive overview of any particular embodiment or example. Additionally, this summary is not intended to identify key/critical elements of an embodiment or example or to delineate the scope of the subject matter of this disclosure. Accordingly, one purpose of this summary may be to present some innovations, embodiments, and/or examples found within this disclosure in a simplified form as a prelude to a more detailed description presented later.

Generally, this disclosure relates to systems, apparatus, and methods for producing three-dimensional (3D) objects in a manner more rapidly and cost efficiently than heretofore achievable. A cylindrical coordinate CNC system (CCCNC system) according to embodiments of this disclosure works by using a rotation and a translation or multiple rotations. In one aspect, a CCCNC system includes a bed that rotates on a platen. The platen translates from side to side (e.g., theta and r-axis, respectively). The rotating bed and the platen define the workspace for producing the 3D objects. In another aspect, the CCCNC system includes a head that moves up and down (z-axis) while remaining static in all other axes of motion. In various embodiments, the CCCNC system uses the r, theta, and z-coordinate system to execute any job or command of which a traditional Cartesian CNC system is capable.

A further understanding of the nature of and equivalents to the subject matter of this disclosure (as well as any inherent or express advantages and improvements provided) should be realized in addition to the above section by reference to the remaining portions of this disclosure, any accompanying drawings, and the claims.

### BRIEF DESCRIPTION OF THE DRAWINGS

In order to reasonably describe and illustrate those innovations, embodiments, and/or examples found within this disclosure, reference may be made to one or more accompanying drawings. The additional details or examples used to describe the one or more accompanying drawings should not be considered as limitations to the scope of any of the claimed inventions, any of the presently described embodiments and/or examples, or the presently understood best mode of any innovations presented within this disclosure.

FIG. 1 depicts a cylindrical coordinate CNC system (CCCNC system) according to an embodiment of this disclosure.

FIG. 2 is an illustration of a perspective view of the CCCNC system of FIG. 1 in one embodiment according to the present invention.

FIG. 3 is an illustration of a top plan view of the CCCNC system of FIG. 1 in one embodiment according to the present invention.

FIG. 4 is an illustration of a side elevation view of the CCCNC system of FIG. 1 in one embodiment according to the present invention.

FIG. 5 is an illustration of a front elevation view of the CCCNC system of FIG. 1 in one embodiment according to the present invention.

FIG. 6 is a flowchart of a method for calibrating rotation of a CCCNC system in one embodiment according to the present invention.

FIG. 7 is an illustration of a top plan view of a rotary build table and platen of a

CCCNC system having endstops for calibrating the rotational axis in one embodiment according to the present invention.

FIG. 8 is an illustration of a side elevation view of a rotary build table and platen of a CCCNC system having endstops for calibrating the rotational axis in one embodiment according to the present invention.

FIG. 9 is a flowchart of a method for calibrating translation of a CCCNC system in one embodiment according to the present invention.

FIG. 10 is an illustration of a side elevation view of a rotary build table and a platen of a CCCNC system having endstops for calibrating the translation axis in one embodiment according to the present invention.

FIG. 11 is a flowchart of a method for calibrating the z-axis of a CCCNC system in one embodiment according to the present invention

FIG. 12 is a simplified block diagram of a computer system that may be used to practice embodiments of the present invention.

### DETAILED DESCRIPTION OF THE INVENTION

### Introduction

In order to better understand one or more of the inventions presented within this disclosure, aspects of at least one environment within which various embodiments may operate will first be described.

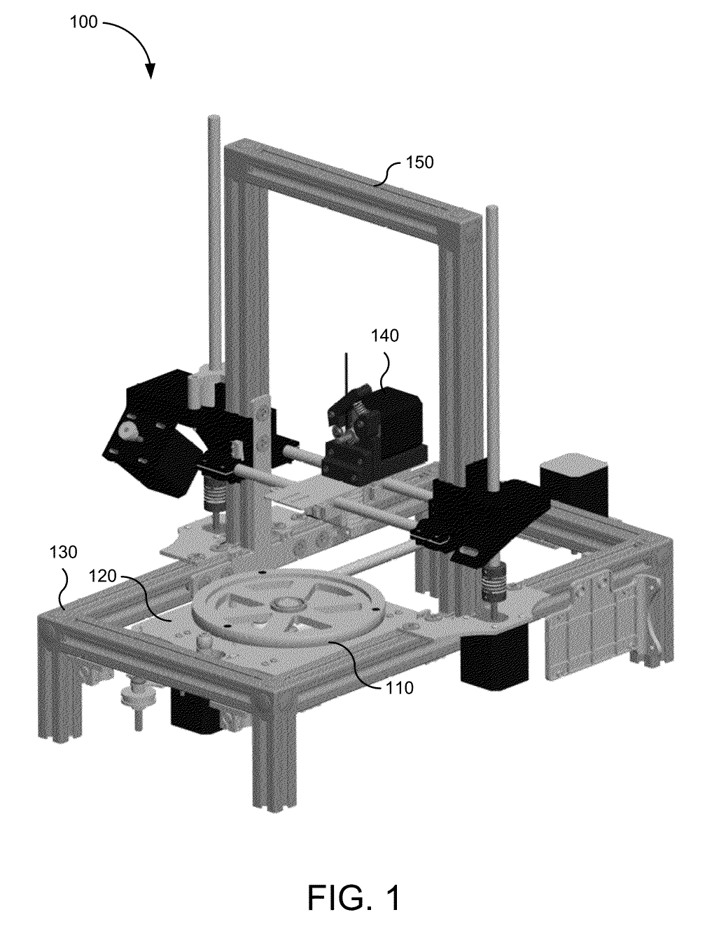

FIG. 1 depicts a cylindrical coordinate CNC system (CCCNC system) 100 according to an embodiment of this disclosure. CCCNC system 100 produces three-dimensional objects by depositing one or more layers of material on a build surface that ultimately form the three-dimensional object. In this example, CCCNC system 100 includes hardware and/or software elements that are typically found in traditional 3D printers, such as supports, motors, printheads, feeding mechanisms, and the like. In contrast to traditional 3D printers, CCCNC system 100 includes a rotary build bed or rotary build table (i.e., rotary build table 110) that rotates within a substantially level plane. The rotation forms a theta axis of motion. Such rotation provides for finer details associated with prints, enhanced curves, as well as other print features that may be discussed herein.

Rotary build table 110 may be formed by any material suitable for 3D printing or for supporting one or more print surfaces. Rotary built table 110 may incorporate one or more components configured to provide a suitable surface for printing 3D objects or to act as support for such surfaces. In this example, rotary built table 110 includes a circular mechanism upon which may be placed one or more materials suitable for receiving build materials. Rotary built table 110 as shown is preferably round or cylindrical in shape. Other shapes may be used for rotary build table 110. In one embodiment, rotary built table 110 is mounted about a shaft attached to one or more motors or other drive mechanism. In a particular embodiment, rotary built table 110 is mounted via the shaft to a rotary actuator (not shown) that rotates rotary built table 110 about the shaft. The rotary actuator could be hydraulically, pneumatically, or electrically driven. In addition, the rotary actuator may include one or more encoders, or similar devices, that cooperate with a controller to monitor and adjust the rotational speed, rotational direction, and/or position of rotary built table 110. Rotary build table 110 is supported by platen 120.

Platen 120 may include one or more motors, drive mechanisms, pulley systems, or other structural or electrical components configured to enable the rotation of rotary build table 110 described above. Platen 120 further may include one or more motors, drive mechanisms, pulley systems, or other structural or electrical components configured to translate platen 120 along one or more predetermined degrees of freedom. In this example, platen 120 is configured to translate linearly from side to side along a single axis to form an r-axis of motion. Platen 120 and rotary build table 110 are supported by structural frame 130.

Structure frame 130 may incorporate a variety of materials and features found in traditional 3D printing to provide support for printed objects as well as other mechanisms or electronic associated with parts of CCCNC system 100. Structure frame 130 may be formed by extruded materials, I-beams, or other common materials used to manufacture 3D printers.

CCCNC system 100, in this example, further includes at least one printhead assembly 140. In the embodiment shown, printhead assembly 140 is mounted to structural frame 150 which is thereby attached to and supported by structural frame 130. Printhead assembly 140 is configured to translate in at least two or more degrees of freedom. For example, printhead assembly 140 may move toward and away from rotary build table 110 forming a z-axis of motion. Printhead assembly 140 may have other degrees of freedom relative to rotary build table 110. One or more encoders associated with rotary built table 110 may be used in the control of firing of one or more printheads associated with printhead assembly 140 such that each printhead prints accurately and repeatedly, regardless of variations in the rotational speed of rotary built table 110.

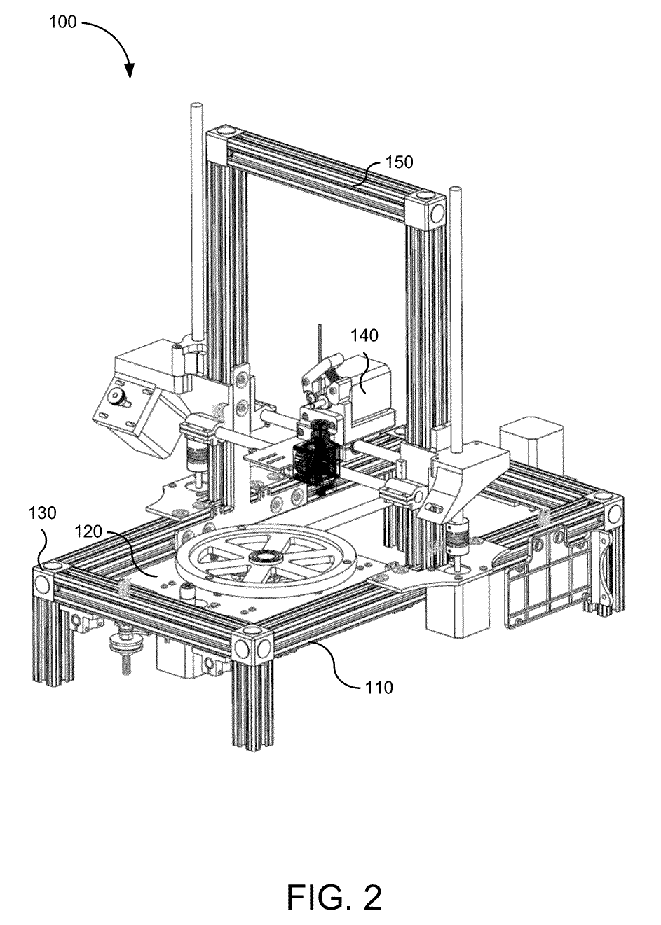

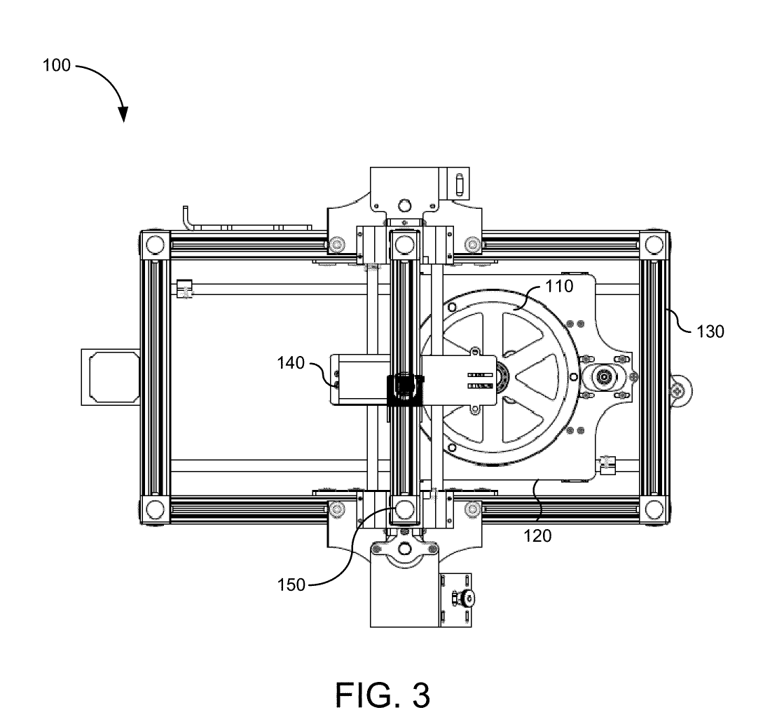

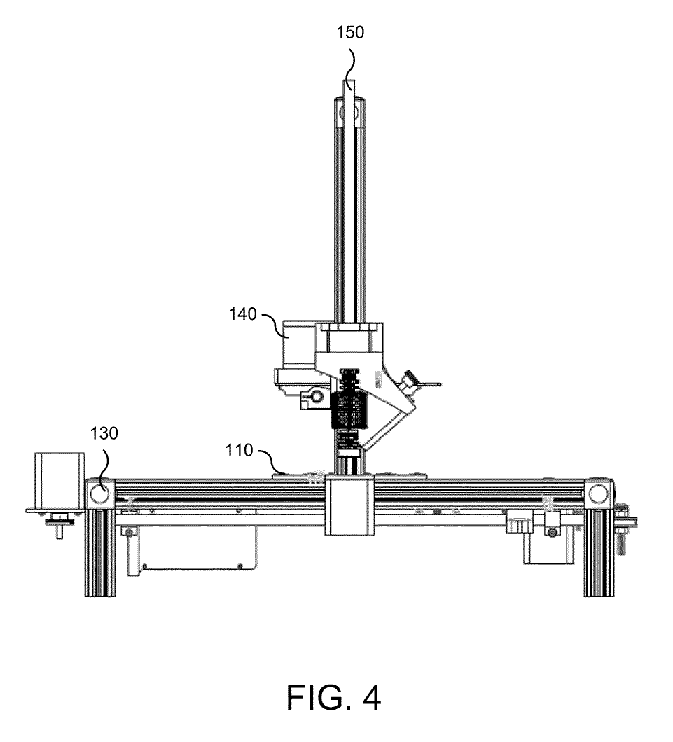

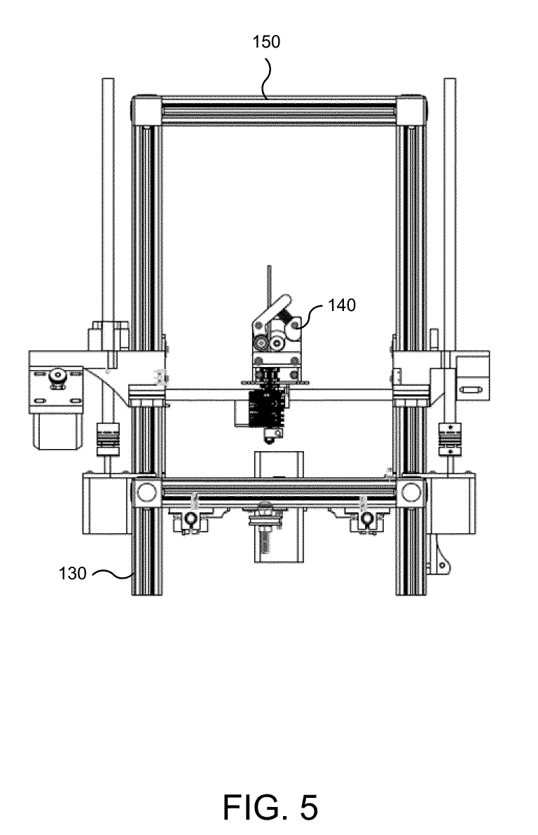

FIGS. 2-5 are illustrations of different views of CCCNC system 100 in various embodiments according to the present invention. CCCNC system 100 may include parts that are similar to those present in a Cartesian coordinate 3D printer. Some examples of parts may include linear rods, linear bearings/bushings, stepper motors, timing belts, etc. In some aspects, CCCNC system 100 includes parts that are unique to or uncommon in Cartesian coordinate 3D printers such as, but are not limited to, large diameter pulleys, circular printing beds, and lower step count motors. In various embodiments, CCCNC system 100 incorporates at least one of these parts to give CCCNC system 100 unique features such as increased precision and accuracy while still using less expensive hardware (lower step count motors for example), and the ability to employ a simpler, sleeker design.

In operation, rotary built table 110 receives build material from one or more build material dispensers (not shown). For example, one or more conduits, tubes, ducts, or other build material delivery mechanisms may dispense build material onto rotary built table 110 as it rotates via one or more printheads mounted to printhead assembly 140. Typically, the one or more printheads deposit a predetermined amount of material onto rotary built table 110 in one or more forms, such as a point, a line, a curve, or the like. The one or more printheads may include one or more nozzles for spraying or otherwise depositing build material onto rotary built table 110.

Printhead assembly 140 may incorporate a variety of techniques for additive manufacturing. For example, printhead assembly 140 may use fused filament fabrication to produce a model by extruding a filament that hardens immediately or relatively quickly to form layers or fused deposition modeling to produce a model by extruding one or more beads each of a predetermined size of one or more materials that harden immediately or relatively quickly to form layers. In one embodiment, a thermoplastic filament or metal wire that is wound on a coil is unreeled to supply material to one or more extrusion nozzle associated with printhead assembly 140. Each nozzle head may be configured to heat a build material and turn the flow of the build material on and off. Various polymers may be used, including acrylonitrile butadiene styrene (ABS), polycarbonate (PC), polylactic acid (PLA), high density polyethylene (HDPE), PC/ABS, and polyphenylsulfone (PPSU).

Printhead assembly 140 may incorporate another 3D printing approach using the selective fusing of build materials in a granular bed. The technique fuses parts of the layer, and then moves printhead assembly 140 upward, adding another layer of granules, and repeating the process until the piece has built up. This process uses the unfused media to support overhangs and thin walls in the part being produced, which reduces the need for temporary auxiliary supports for the piece. A laser is typically used to sinter the media into a solid. Examples include selective laser sintering (SLS), with both metals and polymers (e.g. PA, PA-GF, Rigid GF, PEEK, PS, Alumide, Carbonmide, elastomers), and direct metal laser sintering (DMLS). In another example, printhead assembly 140 may use electron beam melting (EBM) for metal parts (e.g. titanium alloys). EBM manufactures parts by melting metal powder layer by layer with an electron beam in a high vacuum.

In another aspect, printhead assembly 140 may incorporate another method consisting of an inkjet 3D printing system. Printhead assembly 140 creates a model one layer at a time by spreading a layer of powder (plaster, or resins) and printing a binder in the cross-section of the part using an inkjet-like process. This is repeated until every layer has been printed. This technology allows the printing of full color prototypes, overhangs, and elastomer parts. The strength of bonded powder prints can be enhanced with wax or thermoset polymer impregnation.

The operation of printhead assembly 140 may vary in different embodiments to accommodate different build materials and/or multiple layers of a build material. For example, in one embodiment, printhead assembly 140 moves upwardly and downwardly relative to rotary build table 110. In a particular embodiment, one or more threaded screws associated with structural support 150 position printhead assembly 140 relative to rotary build table 110. In another embodiment, printhead assembly 140 may be fixed as rotary build table 110 and platen 120 move relative to printhead assembly 140. Each of rotary build table 110, platen 120, and printhead assembly 140 may be moved in one or more degrees of freedom by, for example, one or more motors, servos, or linear actuators. The motors, servos, or linear actuators may be hydraulically, pneumatically, or electrically driven.

In general, CCCNC system 100 operates by using a rotation and a translation or multiple rotations. In various embodiments, the CCCNC system uses the r, theta, and z-coordinate system to execute any job or command of which a traditional Cartesian CNC system is capable.

### Cylindrical Coordinate Space

As discussed above, Cartesian coordinate CNC machines, such as 3D printers, laser cutters, etc., require calibration before beginning the printing or machining process in order to define and constrain the “virtual workspace.” Without doing this the printing or cutting may occur outside the physical confines of the physical workspace. In contrast, CCCNC system 100 operates by using a rotation and a translation or multiple rotations. Referring again to FIG. 1, rotary build bed 100 rotates on platen 120 and platen 120 translates from side to side (the theta and r-axis, respectively) to define the workspace. In conjunction, printhead assembly 140 moves up and down (the z-axis) with the option of remaining static in all other axes of motion. Using the r, theta, z coordinate system, CCCNC system 100 is capable of executing any job or command that Cartesian coordinate CNC machines are capable of.

With the execution of jobs in Cylindrical coordinate space, CCCNC system 100 provides several improvements over Cartesian coordinate CNC machines. For example, CCCNC system 100 allows for higher resolution prints. In Cartesian coordinate CNC machines, there is a minimum value in which any motor is able to turn. The smaller this value, the higher the resolution of the machine leading to higher quality jobs. In order to improve this resolution, gearing is needed to reduce the minimum travel distance. However when gearing is used, more transfer of motion occurs which leads to increased backlash (inaccuracy due to changing direction). Backlash causes inaccuracy in the print and lowers the fidelity of a job. Backlash can be eliminated by using expensive hardware and as such is not a cost effective solution for most consumers. CCCNC system 100, by operating in Cylindrical coordinate space, provides a higher gearing ratio that can be achieved with less hardware while reducing or avoiding backlash. In one embodiment, CCCNC system 100 utilizes rotary build table 110 itself as a large gear and has motion directly transferred to it from a motor via a belt.

In another aspect CCCNC system 100 increases the accuracy of spline and cylindrical geometry. Cartesian coordinate CNC machines that are setup to print in Cartesian coordinate space inherently print/cut curves as a series of small straight lines to emulate a curve (the smaller the line, the more accurate the curve). This is because the axes of motion are designed to move back and forth and side to side in straight lines and to execute an arc command requires simultaneous motion from both axes. This also leads to more potential imperfections due to the need for two independent motions, each containing some amount of backlash, to execute a single action. CCCNC system 100, by operating in Cylindrical coordinate space, allows curves to be created differently than those inherently created as a series of straight lines. Because one of the axes is a circular motion, CCCNC system 100 does not require two independent motions at all times to execute a single action to produce a curve. This difference in motion leads to an improvement in finished products that can be seen and felt.

In yet another aspect, CCCNC system 100 provides a lower initial cost. As mentioned previously, material costs for CCCNC system 100 is lower than Cartesian coordinate CNC machines because less hardware is needed. CCCNC system 100 requires less linear bearings, less linear rods, and less gears and motion transfer devices.

### Cylindrical Coordinate Methods of Calibration for CNC Applications

In various embodiments, CCCNC system 100 incorporates a variety of techniques for calibrating rotary build bed 110. CCCNC system 100, just as with other CNC machines, may require calibration before beginning a job to define the virtual workspace. In various embodiments, CCCNC system 100 incorporates a variety of endstops similar to Cartesian CNC calibration. Since the movement in Cylindrical coordinate space consists of one or more rotations and translation, calibration of CCCNC system 100 is maximized when 360 degrees can be defined in the virtual workspace. The calibration of CCCNC system 100 also can be maximized by locating the exact center of rotary build bed 110. If not done correctly, CCCNC system 100 may generate prints that have deformations and loss of fidelity.

To better illustrate, consider a situation in which a false signal is sent to a CPU managing a print job of CCCNC system 100. The following three scenarios demonstrate what happens to a print if calibration is incorrect. In the first example, if a false signal occurs in the rotation calibration (assuming the translation is perfectly calibrated), a part will be printed/cut in the correct location but each layer will be rotated relative to the previous layer. A part that meant to be built straight up may turn out being diagonal. In the second example, if a false signal occurs in the translation (assuming the rotation is perfectly calibrated), a part will be printed/cut off center and distortion may occur. Specifically, circles may become ovals, straight lines may become curves, etc. In the third example, if a false signal occurs in both the translation and the rotation, then all of the effects in the 2 previous scenarios may occur.

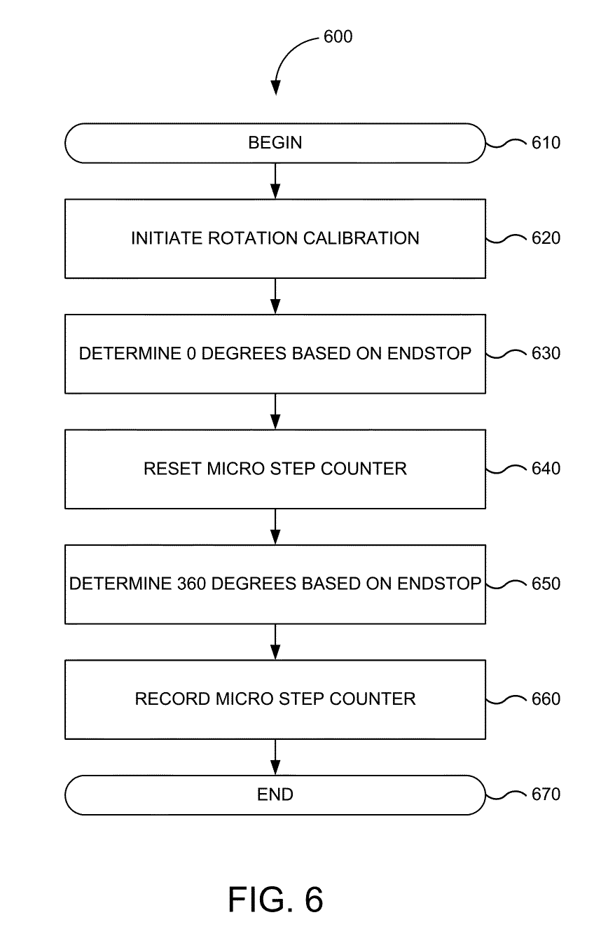

Accordingly, CCCNC system 100 incorporates techniques discussed herein that maintaining the fidelity and accuracy of prints/cuts using an improved calibration process for cylindrical coordinates. FIG. 6 is a flowchart of method 600 for calibrating rotation of CCCNC system 100 in one embodiment according to the present invention. Implementations of or processing in method 600 depicted in FIG. 6 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 600 depicted in FIG. 6 begins in step 610.

In step 620, rotation calibration is initiated. In this example, CCCNC system 100 includes an endstop placed next to the rotating axis, shaft, or an object that rotates in sync with rotary build table 110 such that the position and orientation of a limit switch/photo-interrupter is perpendicular to rotation. CCCNC system 100 may include a tab or object that protrudes from the rotating axis, shaft, or object that rotates in sync with rotary build table 110 and acts as a trigger for the endstop as it rotates.

In step 630, a determination is made whether an endstop is activated. For example, CCCNC system 100 begins rotating the rotating axis until the protruding tab activates the endstop. CCCNC system 100 can then retreat the axis by a set amount and approach the endstop at a lower speed, to increase the accuracy, until the endstop is activated once again.

In step 640, a determination is made for the location of 0 degrees. For example, when CCCNC system 100 receives this signal, CCCNC system 100 defines 0 degrees at this point. In step 650, CCCNC system 100 sets a current micro step position of the rotation motor to zero. CCCNC system 100 then continues the rotation in the same direction until the endstop is activated again. CCCNC system 100 can again retreat the axis a set amount and approach the endstop at a lower speed until the endstop is activated once again.

In step 660, a determination is made for the location of 360 degrees. For example, when CCCNC system 100 receives this signal, CCCNC system 100 defines 360 degrees at this point. In step 660, CCCNC system 100 records the number of micro steps of the motor. FIG. 6 ends in step 670.

In various embodiments, CCCNC system 100 repeats method 660 and averages the results to improve accuracy. In one aspect, CCCNC system 100 may perform method 600 by passing the end stop multiple times. CCCNC system 100 then calculates the steps per degree based on a number of complete rotations encountered. By rotating a larger number of degrees for the calibration sequence, CCCNC system 100 reduces any error in the endstop accuracy.

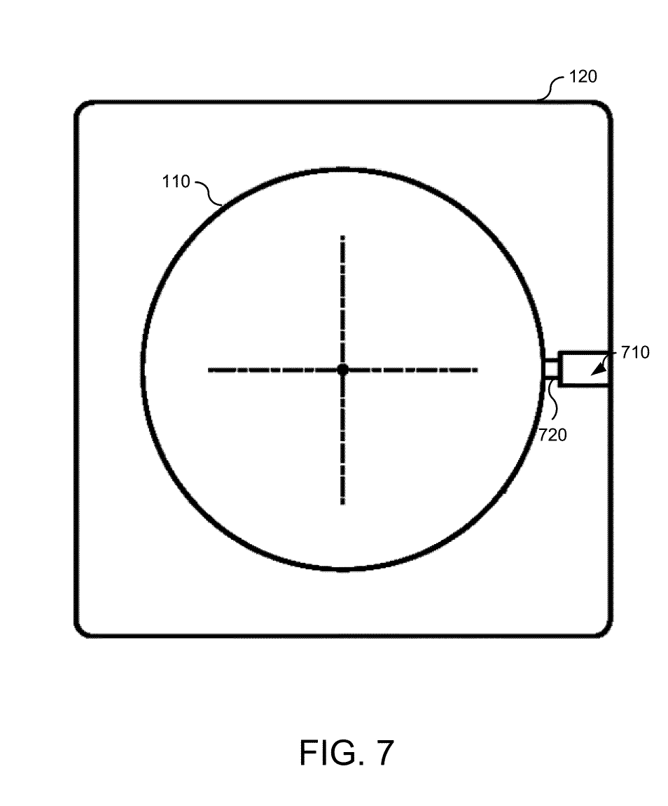

FIG. 7 is an illustration of a top plan view of rotary build table 110 and platen 120 having endstops for calibrating the rotational axis in one embodiment according to the present invention. In this example, CCCNC system 100 includes endstop 710 supported by platen 120 and endstop actuator tab 720 attached to rotary build bed 110.

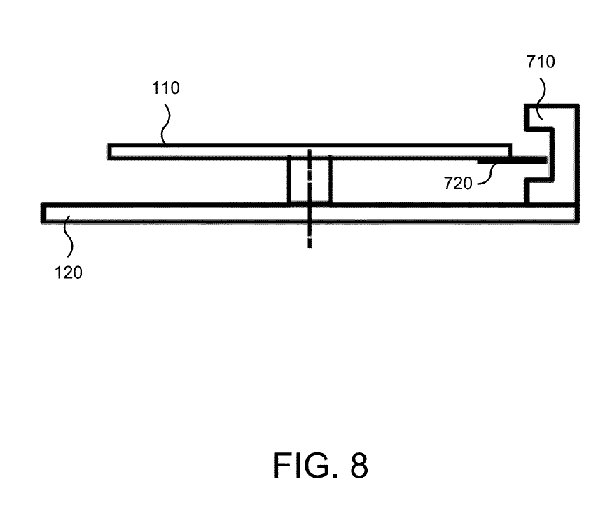

FIG. 8 is an illustration of a side elevation view of rotary build table 110 and platen 120 having endstops for calibrating the rotational axis in one embodiment according to the present invention.

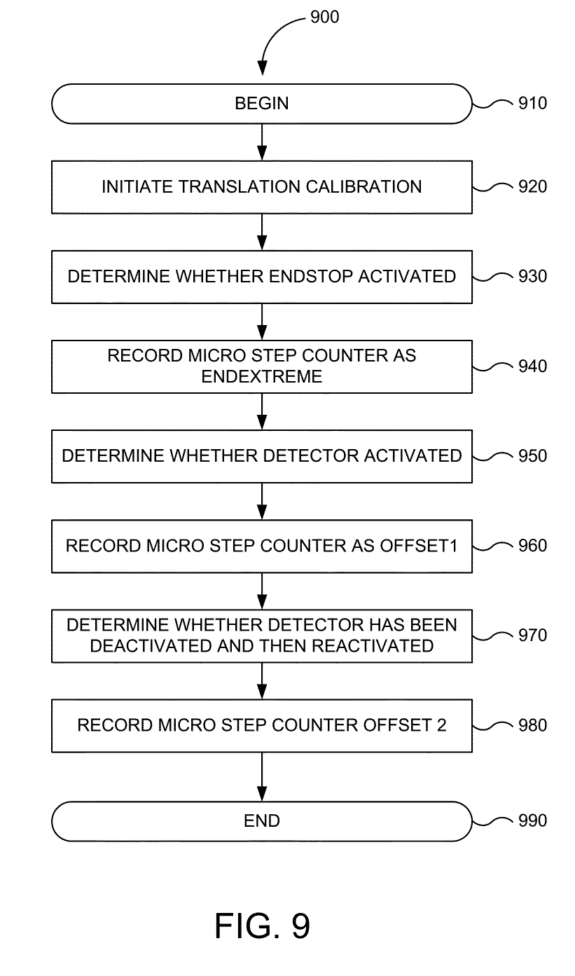

FIG. 9 is a flowchart of method 900 for calibrating translation of CCCNC system 100 in one embodiment according to the present invention. Implementations of or processing in method 900 depicted in FIG. 9 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 900 depicted in FIG. 9 begins in step 910.

In general, CCCNC system 100 utilizes two or more endstops for calibrating the translational axis. A first endstop may be positioned on either side of the workspace, fixed to the workspace or fixed to a stationary point on CCCNC system 100. A second endstop may be a combination of a photo emitter (referred to as the emitter; can be a laser or any type of light source) and a photo detector (referred to as the detector; can be any type of receiver that can detect a wavelength of light equal to that being emitted by the emitter); one of which will be fixed to the head a known distance from the plane of action and the other fixed to the workspace, beneath the platen, and aligned with the center of the axis of rotation (theta axis). A clear path is presented that allows either the emitter or the detector to have a clear line of sight to the other when aligned along the z-axis (referred to as the plane of activation). Either the detector or emitter can be placed on either the head or workspace.

In step 920, translation calibration is initiated. For example, CCCNC system 100 begins moving the workspace towards a designated extremity in which an endstop is placed. In step 930, a determination is made whether the endstop is activated. CCCNC system 100 can then retreat the workspace by a set amount and approach the endstop at a lower speed until the endstop is activated once again to increase accuracy. When CCCNC system 100 receives this signal, CCCNC system 100 records the number of micro steps of the stepper motor. CCCNC system 100 may assign the value to a variable (referred to herein as “endExtreme”). Subsequently CCCNC system 100 moves the workspace in the opposite direction.

In step 950, a determination is made whether a detector is activated. Upon receiving this signal, CCCNC system 100 records the number of micro steps of the stepper motor in step 960. Again, CCCNC system 100 may assign the value to a variable (referred to herein as “offset1”). CCCNC system 100 may then move the workspace in the same direction. In step 970, a determination is made whether the detector is no longer activated. At this point, CCCNC system 100 may move the workspace in the opposite direction until the detector is activated again. Upon receiving this signal, CCCNC system 100 records the number of micro steps of the stepper motor in step 980. CCCNC system 100 may assign it to a variable (referred to herein as “offset2”).

In various embodiments, CCCNC system 100 subtracts offset1 from offset2 and divides the difference by two to obtain an average. CCCNC system 100 subtracts the absolute value of the average from endExtreme. CCCNC system 100 may assign this value to a variable (referred to herein as endOffset). The absolute value of endOffset generally represents the distance of the plane of activation from the endstop at the extremity. CCCNC system 100 may then add or subtract endOffset (as designated by design) from a known distance between the axis of action and the axis of activation. The value calculated represents the distance from the endstop at the extremity to the center of the bed. FIG. 9 ends with step 990.

In an alternative configuration, CCCNC system 100 uses two endstops for the translational axis; one on each side of the workspace, either fixed to the workspace or fixed to a stationary point on the machine. After the calibration sequence is initiated, CCCNC system 100 moves the workspace towards one of the extremities until the endstop is activated. CCCNC system 100 can then retreat the workspace by a set amount and approach the endstop at a lower speed until the endstop is activated once again to increase accuracy. CCCNC system 100 marks this point as either the maximum or the minimum, and CCCNC system 100 records the number of micro steps of the motor. Note that at this point the number of micro steps is arbitrary.

Subsequently, CCCNC system 100 moves the workspace in the opposite direction towards the other extremity until the remaining endstop is activated. CCCNC system 100, may then retreat the workspace by a set amount and approach the endstop at a lower speed until the endstop is activated once again. CCCNC system 100 again marks either the maximum or the minimum, and CCCNC system 100 records the number of micro steps of the motor.

CCCNC system 100 calculates the difference between the micro steps recorded at each extremity and determines the average. The final number obtained from these calculations represents the number of micro steps from one endstop to the center of the bed in the virtual workspace. CCCNC system 100 may repeat this process and average the results to improve accuracy.

In yet another alternative configuration, CCCNC system 100 uses two endstops for the translational axis; 1 placed so that the endstop aligns with the head and the other placed at one of the extremities. CCCNC system 100 incorporates a tab protruding from platen 120 or a part that moves in sync with platen 120 that demarcates the center of the bed either by being directly centered or a known distance from the center.

After the calibration process is initiated, CCCNC system 100 moves the translational axis to the extremity in which the endstop is located until the endstop is activated. CCCNC system 100 may then retreat the workspace by a set amount and approach the endstop at a lower speed until the endstop is activated once again. CCCNC system 100 then moves the workspace in the opposite direction until the protruding tab activates the second endstop. CCCNC system 100 may retreat the workspace by a set amount and approach the endstop at a lower speed until the endstop is activated once again. CCCNC system 100 record this location as the center of the bed. CCCNC system 100 may repeat this process and average the results to improve accuracy.

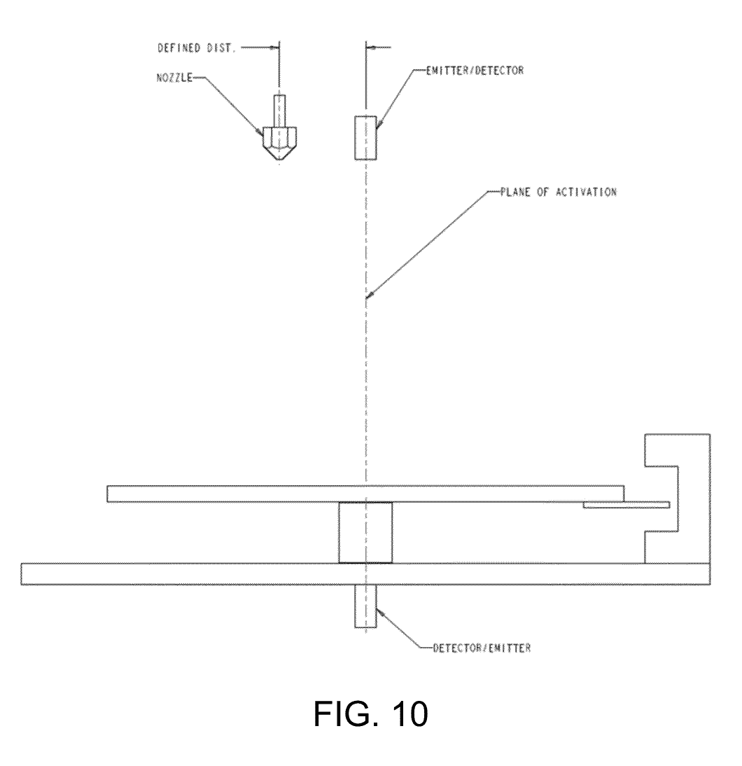

FIG. 10 is an illustration of a side elevation view of rotary build table 110 and platen 120 having endstops for calibrating the translation axis in one embodiment according to the present invention.

In further embodiments, CCCNC system 100 implements auto calibration of the z-axis. In one aspect, CCCNC system 100 determines the z-position of one or more nozzles associated with printhead assembly 140 relative to rotary bed 140. To accomplish this, CCCNC system 100 incorporates an endstop affixed near (and above) a printing plane (so as not to obstruct during a print process).

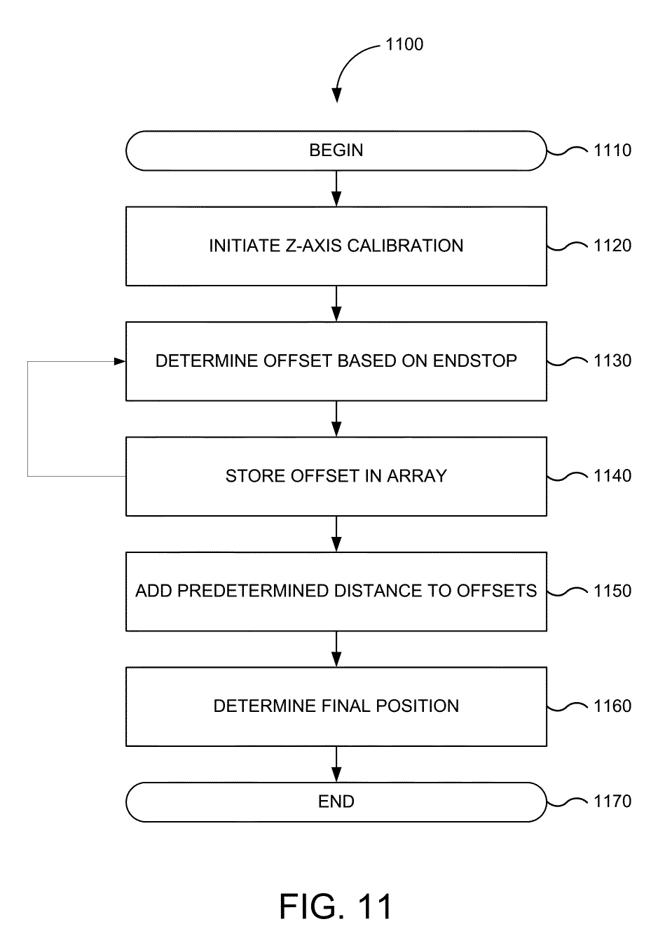

FIG. 11 is a flowchart of method 1100 for calibrating the z-axis of CCCNC system 100 in one embodiment according to the present invention. Implementations of or processing in method 100 depicted in FIG. 11 may be performed by software (e.g., instructions or code modules) when executed by a central processing unit (CPU or processor) of a logic machine, such as a computer system or information processing device, by hardware components of an electronic device or application-specific integrated circuits, or by combinations of software and hardware elements. Method 1100 depicted in FIG. 11 begins in step 1110.

In step 1120, z-axis calibration is initiated. In this example, CCCNC system 100 begins moving a print bed first translationally out of the way of a print nozzle but in line with an endstop allowing the print nozzle to be lowered below the position of a printing plane. In step 1130, a determination is made whether an endstop is activated. CCCNC system 100 continues until the endstop is triggered by contact with the print bed. CCCNC system 100 then records this position to a variable as “zOffset.” CCCNC system 100 may repeat this operation as necessary with the bed rotating every iteration. In step 1140, the offset value is stored in an array. CCCNC system 100 may store the offsets in a variable “zArray.” CCCNC system 100 can then determine any deviation of the bed from the nominal printing plane while a job is running

In step 1150, a predetermined distance is added to each zOffset in ZArray. CCCNC system 100 may add a variable “zOffsetNozzle” to all values of the zArray. This has the effect of bringing the nozzle of the extruder level with the printing plane. In step 1160, a final position is determined. CCCNC system 100 may assign a final position to a variable zZero that brings the nozzle of the extruder level with the printing plane. FIG. 11 ends in step 1170.

### Conclusion

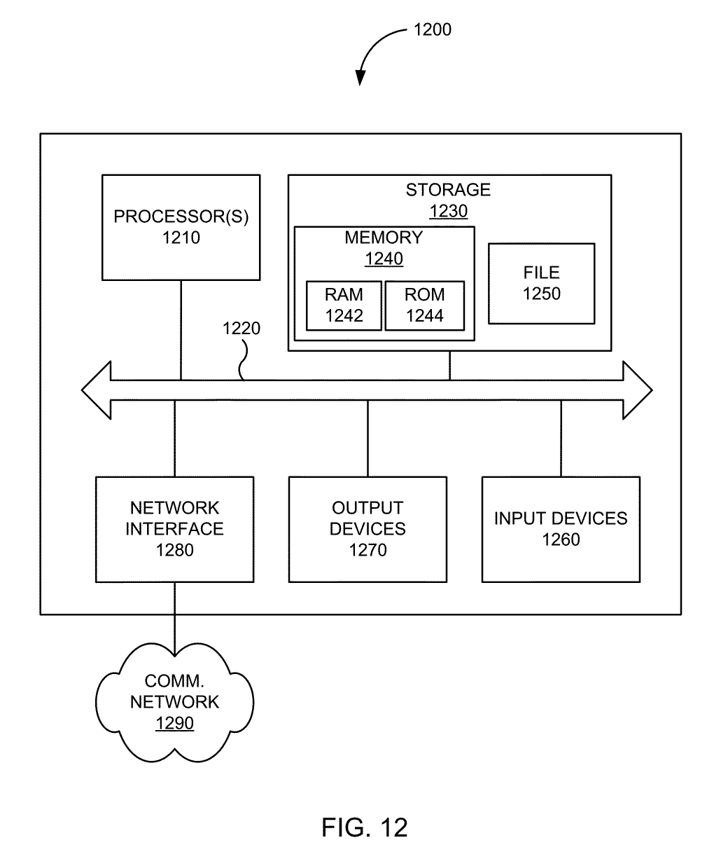

FIG. 12 is a simplified block diagram of computer system 1200 that may be used to practice embodiments of the present invention. As shown in FIG. 12, computer system 1200 includes processor 1210 that communicates with a number of peripheral devices via bus subsystem 1220. These peripheral devices may include storage subsystem 1230, comprising memory subsystem 1240 and file storage subsystem 1250, input devices 1260, output devices 1270, and network interface subsystem 1280.

Bus subsystem 1220 provides a mechanism for letting the various components and subsystems of computer system 1200 communicate with each other as intended. Although bus subsystem 1220 is shown schematically as a single bus, alternative embodiments of the bus subsystem may utilize multiple buses.

Storage subsystem 1230 may be configured to store the basic programming and data constructs that provide the functionality of the present invention. Software (code modules or instructions) that provides the functionality of the present invention may be stored in storage subsystem 1230. These software modules or instructions may be executed by processor(s) 1210. Storage subsystem 1230 may also provide a repository for storing data used in accordance with the present invention. Storage subsystem 1230 may comprise memory subsystem 1240 and file/disk storage subsystem 1250.

Memory subsystem 1240 may include a number of memories including a main random access memory (RAM) 1242 for storage of instructions and data during program execution and a read only memory (ROM) 1244 in which fixed instructions are stored. File storage subsystem 1250 provides persistent (non-volatile) storage for program and data files, and may include a hard disk drive, a floppy disk drive along with associated removable media, a Compact Disk Read Only Memory (CD-ROM) drive, a DVD, an optical drive, removable media cartridges, and other like storage media.

Input devices 1260 may include a keyboard, pointing devices such as a mouse, trackball, touchpad, or graphics tablet, a scanner, a barcode scanner, a touchscreen incorporated into the display, audio input devices such as voice recognition systems, microphones, and other types of input devices. In general, use of the term “input device” is intended to include all possible types of devices and mechanisms for inputting information to computer system 1200.

Output devices 1270 may include a display subsystem, a printer, a fax machine, or non-visual displays such as audio output devices, etc. The display subsystem may be a cathode ray tube (CRT), a flat-panel device such as a liquid crystal display (LCD), or a projection device. In general, use of the term “output device” is intended to include all possible types of devices and mechanisms for outputting information from computer system 1200.

Network interface subsystem 1280 provides an interface to other computer systems, devices, and networks, such as communications network 1290. Network interface subsystem 1280 serves as an interface for receiving data from and transmitting data to other systems from computer system 1200. Some examples of communications network 1290 are private networks, public networks, leased lines, the Internet, Ethernet networks, token ring networks, fiber optic networks, and the like.

Computer system 1200 can be of various types including a personal computer, a portable computer, a workstation, a network computer, a mainframe, a kiosk, or any other data processing system. Due to the ever-changing nature of computers and networks, the description of computer system 1200 depicted in FIG. 12 is intended only as a specific example for purposes of illustrating the preferred embodiment of the computer system. Many other configurations having more or fewer components than the system depicted in FIG. 12 are possible.

Although specific embodiments of the invention have been described, various modifications, alterations, alternative constructions, and equivalents are also encompassed within the scope of the invention. The described invention is not restricted to operation within certain specific data processing environments, but is free to operate within a plurality of data processing environments. Additionally, although the present invention has been described using a particular series of transactions and steps, it should be apparent to those skilled in the art that the scope of the present invention is not limited to the described series of transactions and steps.

Further, while the present invention has been described using a particular combination of hardware and software, it should be recognized that other combinations of hardware and software are also within the scope of the present invention. The present invention may be implemented only in hardware, or only in software, or using combinations thereof.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

Various embodiments of any of one or more inventions whose teachings may be presented within this disclosure can be implemented in the form of logic in software, firmware, hardware, or a combination thereof. The logic may be stored in or on a machine-accessible memory, a machine-readable article, a tangible computer-readable medium, a computer-readable storage medium, or other computer/machine-readable media as a set of instructions adapted to direct a central processing unit (CPU or processor) of a logic machine to perform a set of steps that may be disclosed in various embodiments of an invention presented within this disclosure. The logic may form part of a software program or computer program product as code modules become operational with a processor of a computer system or an information-processing device when executed to perform a method or process in various embodiments of an invention presented within this disclosure. Based on this disclosure and the teachings provided herein, a person of ordinary skill in the art will appreciate other ways, variations, modifications, alternatives, and/or methods for implementing in software, firmware, hardware, or combinations thereof any of the disclosed operations or functionalities of various embodiments of one or more of the presented inventions.

The disclosed examples, implementations, and various embodiments of any one of those inventions whose teachings may be presented within this disclosure are merely illustrative to convey with reasonable clarity to those skilled in the art the teachings of this disclosure. As these implementations and embodiments may be described with reference to exemplary illustrations or specific figures, various modifications or adaptations of the methods and/or specific structures described can become apparent to those skilled in the art. All such modifications, adaptations, or variations that rely upon this disclosure and these teachings found herein, and through which the teachings have advanced the art, are to be considered within the scope of the one or more inventions whose teachings may be presented within this disclosure. Hence, the present descriptions and drawings should not be considered in a limiting sense, as it is understood that an invention presented within a disclosure is in no way limited to those embodiments specifically illustrated.

Accordingly, the above description and any accompanying drawings, illustrations, and figures are intended to be illustrative but not restrictive. The scope of any invention presented within this disclosure should, therefore, be determined not with simple reference to the above description and those embodiments shown in the figures, but instead should be determined with reference to the pending claims along with their full scope or equivalents.

What is claimed is:

1. A machine-implemented method for calibrating a 3D printer implementing a cylindrical coordinate space as described herein.

2. A device for calibrating a 3D printer implementing a cylindrical coordinate space as described herein.

3. A non-transitory computer-readable medium storing machine-executable code for calibrating a 3D printer implementing a cylindrical coordinate space as described herein.

4. A method for calibrating a 3D printer implementing a cylindrical coordinate space, the method comprising:
receiving, at a processor associated with the 3D printer, an instruction to initiate calibration of a deposition area of the 3D printer about a rotational axis of the 3D printer;
determining, with the processor, a first metric indicative of one or more rotations of the deposition area about the rotational axis;
receiving, at the processor, an instruction to initiate calibration of the deposition area of the 3D printer along a translational axis of the 3D printer;
determining, with the processor, a second metric indicative of a center of a first portion of the deposition area relative to a portion of the translational axis;
receiving, at the processor, an instruction to initiate calibration of the deposition area of the 3D printer along a z-axis of the 3D printer;
determining, with the processor, a third metric indicative of a portion of a plane of the deposition area relative to a portion of the z-axis; and
generating, with the processor, calibration information based on the first metric indicative of the one or more rotations of the deposition area about the rotational axis, the second metric indicative of the center of the first portion of the deposition area relative to the portion of the translational axis, and the third metric indicative of the portion of the plane of the deposition area relative to the portion of the z-axis.

5. The method of claim 4 wherein determining, with the processor, the first metric indicative of the one or more rotations of the deposition area about the rotational axis comprises determining a number of steps required to complete a predetermined rotation of the deposition area about the rotational axis.

6. The method of claim 4 wherein determining, with the processor, the first metric indicative of the one or more rotations of the deposition area about the rotational axis comprises:
rotating the deposition area about the rotational axis until a first signal is received;
setting a first counter based on the first signal;
rotating the deposition area about the rotational axis until a second signal is received; and
determining the first metric based on a difference between the first signal and the second signal.

7. The method of claim 6 further comprising repeating a plurality of times the step of rotating the deposition area about the rotational axis until the second signal is received, wherein determining the first metric based on the difference between the first signal and the second signal includes determining the first metric based on multiple differences between the first signal and a plurality of second signals.

8. The method of claim 4 wherein determining, with the processor, the second metric indicative of the center of the first portion of the deposition area relative to the portion of the translational axis comprises determining a number of steps required to complete a predetermined translation of the first portion of the deposition area along the translational axis.

9. The method of claim 4 wherein determining, with the processor, the second metric indicative of the center of the first portion of the deposition area relative to the portion of the translational axis comprises:
translating the first portion of the deposition area along the translational axis until a first signal is received;
setting a first counter based on the first signal;
translating the first portion of the deposition area along the translational axis until a second signal is received; and
determining the second metric based on a difference between the first signal and the second signal.

10. The method of claim 6 further comprising repeating a plurality of times the step of translating the first portion of the deposition area along the translational axis until the second signal is received, wherein determining the second metric based on the difference between the first signal and the second signal includes determining the second metric based on multiple differences between the first signal and a plurality of second signals.

11. The method of claim 4 wherein determining, with the processor, the third metric indicative of the portion of the plane of the deposition area relative to the portion of the z-axis comprises:
translating a portion of the 3D printer along the z-axis until below the portion of the plane of the deposition area until a first signal is received;
repeating a plurality of times the step of translating the portion of the 3D printer along the z-axis until contact is made with the portion of the plane of the deposition area generating a plurality of second signals; and
determining the third metric based on differences between the first signal and the plurality of second signals.

12. A non-transitory computer-readable medium storing code executable by a processor of a 3D printer implementing a cylindrical coordinate space, the non-transitory computer-readable medium comprising:
code for receiving an instruction to initiate calibration of a deposition area of the 3D printer about a rotational axis of the 3D printer;
code for determining a first metric indicative of one or more rotations of the deposition area about the rotational axis;
code for receiving an instruction to initiate calibration of the deposition area of the 3D printer along a translational axis of the 3D printer;
code for determining a second metric indicative of a center of a first portion of the deposition area relative to a portion of the translational axis;
code for receiving an instruction to initiate calibration of the deposition area of the 3D printer along a z-axis of the 3D printer;
code for determining a third metric indicative of a portion of a plane of the deposition area relative to a portion of the z-axis; and
code for generating calibration information based on the first metric indicative of the one or more rotations of the deposition area about the rotational axis, the second metric indicative of the center of the first portion of the deposition area relative to the portion of the translational axis, and the third metric indicative of the portion of the plane of the deposition area relative to the portion of the z-axis.

13. The non-transitory computer-readable medium of claim 12 wherein the code for determining the first metric indicative of the one or more rotations of the deposition area about the rotational axis comprises code for determining a number of steps required to complete a predetermined rotation of the deposition area about the rotational axis.

14. The non-transitory computer-readable medium of claim 12 wherein the code for determining the first metric indicative of the one or more rotations of the deposition area about the rotational axis comprises:
code for rotating the deposition area about the rotational axis until a first signal is received;
code for setting a first counter based on the first signal;
code for rotating the deposition area about the rotational axis until a second signal is received; and
code for determining the first metric based on a difference between the first signal and the second signal.

15. The non-transitory computer-readable medium of claim 14 further comprising code for repeating a plurality of times rotating of the deposition area about the rotational axis until the second signal is received, wherein the code for determining the first metric based on the difference between the first signal and the second signal includes code for determining the first metric based on multiple differences between the first signal and a plurality of second signals.

16. The non-transitory computer-readable medium of claim 12 wherein the code for determining the second metric indicative of the center of the first portion of the deposition area relative to the portion of the translational axis comprises code for determining a number of steps required to complete a predetermined translation of the first portion of the deposition area along the translational axis.

17. The non-transitory computer-readable medium of claim 12 wherein the code for determining the second metric indicative of the center of the first portion of the deposition area relative to the portion of the translational axis comprises:
code for translating the first portion of the deposition area along the translational axis until a first signal is received;
code for setting a first counter based on the first signal;
code for translating the first portion of the deposition area along the translational axis until a second signal is received; and
code for determining the second metric based on a difference between the first signal and the second signal.

18. The non-transitory computer-readable medium of claim 17 further comprising code for repeating a plurality of times translating of the first portion of the deposition area along the translational axis until the second signal is received, wherein determining the second metric based on the difference between the first signal and the second signal includes determining the second metric based on multiple differences between the first signal and a plurality of second signals.

19. The non-transitory computer-readable medium of claim 12 wherein the code for determining the third metric indicative of the portion of the plane of the deposition area relative to the portion of the z-axis comprises:
code for translating a portion of the 3D printer along the z-axis until below the portion of the plane of the deposition area until a first signal is received;
code for repeating a plurality of times translating of the portion of the 3D printer along the z-axis until contact is made with the portion of the plane of the deposition area generating a plurality of second signals; and
code for determining the third metric based on differences between the first signal and the plurality of second signals.

20. A calibration system for a 3D printer implementing a cylindrical coordinate space, the calibration system comprising:
a hardware processor; and
a memory configured to store a set of instructions which when executed by the processor configure the processor to:
receive an instruction to initiate calibration of a deposition area of the 3D printer about a rotational axis of the 3D printer;
determine a first metric indicative of one or more rotations of the deposition area about the rotational axis;
receive an instruction to initiate calibration of the deposition area of the 3D printer along a translational axis of the 3D printer;
determine a second metric indicative of a center of a first portion of the deposition area relative to a portion of the translational axis;
receive an instruction to initiate calibration of the deposition area of the 3D printer along a z-axis of the 3D printer;
determine a third metric indicative of a portion of a plane of the deposition area relative to a portion of the z-axis; and
generate calibration information based on the first metric indicative of the one or more rotations of the deposition area about the rotational axis, the second metric indicative of the center of the first portion of the deposition area relative to the portion of the translational axis, and the third metric indicative of the portion of the plane of the deposition area relative to the portion of the z-axis.

21. A 3D printing device implementing a cylindrical coordinate space, the 3D printing device comprising:
a plurality of endstops each configured to generate at least one signal when activated; and
a microcontroller in communication with each of the plurality of endstops and configured to:
receive an instruction to initiate calibration of a deposition area of a printing plate about a rotational axis provided by a base structure;
cause one or more rotations of one or more rotations of the deposition area of the printing plate about the rotational axis provided by the base structure
determine a first metric indicative of a complete of the deposition area of the printing plate about the rotational axis provided by the base structure using information provided by one or more of the plurality of endstops;
receive an instruction to initiate calibration of the deposition area along a translational axis of the base structure;
cause one or more translations of the base structure along the translational axis of the base structure;
determine a second metric indicative of a center of the deposition area of the printing plate using information provided by one or more of the plurality of endstops;
receive an instruction to initiate calibration of the deposition area of the 3D printer along a z-axis;
cause one or more translations of a printhead assembly along the z-axis;
determine a third metric indicative of a plane of the deposition area of the printing plate using information provided by one or more of the plurality of endstops; and
generate calibration information based on the first metric, the second metric, and the third metric.
